(19) United States
(12) Patent Application Publication
(10) Pub. No.: US 2026/0066558 A1
(43) Pub. Date: Mar. 5, 2026

(54) CONNECTOR STRIP

(71) Applicant: WAGO Verwaltungsgesellschaft mbH, Minden (DE)

(72) Inventor: Rudolf MASTEL, Minden (DE)

(73) Assignee: WAGO Verwaltungsgesellschaft mbH, Minden (DE)

(21) Appl. No.: 19/319,291

(22) Filed: Sep. 4, 2025

(30) Foreign Application Priority Data
Sep. 4, 2024 (DE) 20 2024 105 037.1

(51) Int. Cl. H01R 12/70; H01R 12/72

(52) U.S. Cl. CPC H01R 12/707; H01R 12/722

(57) ABSTRACT

A connector strip configured for soldering to an electrical printed circuit board, having an insulating housing and multiple electrical contact elements that are fixed in place in the insulating housing and are arranged next to, and spaced apart from, one another in a row direction, wherein each contact element has at least one electrical plug-in contact that, on a mating face side of the connector strip, is configured for insertion of a mating plug contact associated as a mating part. At least one soldering section is configured for soldering into or soldering onto a solder terminal of the electrical printed circuit board. The electrical plug-in contacts are spaced uniformly apart from one another in a predetermined contact spacing in the row direction.

This nonprovisional application claims priority under 35 U.S.C. § 119(a) to German Patent Application No. 20 2024 105 037.1, which was filed in Germany on Sep. 4, 2024, and which is herein incorporated by reference.

### BACKGROUND OF THE INVENTION

### Field of the Invention

The present invention relates to a connector strip configured for soldering to an electrical printed circuit board, having an insulating housing and multiple electrical contact elements that are fixed in place in the insulating housing and are arranged next to, and spaced apart from, one another in a row direction, wherein each contact element has at least one electrical plug-in contact that, on a mating face side of the connector strip, is configured for insertion of a mating plug contact associated as a mating part, and at least one soldering section that is configured for soldering into or soldering onto a solder terminal of the electrical printed circuit board, wherein the electrical plug-in contacts are spaced uniformly apart from one another in a predetermined contact spacing in the row direction.

### Description of the Background Art

A connector strip is known from, for example, DE 10 2012 105 508 A1, which corresponds to US2015/0188248, which is incorporated herein by reference. The plug-in contacts of the contact elements there are arranged in a predetermined contact spacing of the connecter system that has uniform distances between the adjacent plug-in contacts.

### SUMMARY OF THE INVENTION

It is therefore an object of the present invention to provide a connector strip that is further improved in comparison therewith.

This object is attained, in an example, in a connector strip of the abovementioned type by the means that the distance between the soldering sections in a first pair of immediately adjacent contact elements is greater than the distance defined by the contact spacing and/or is greater than the distance between the soldering sections of a second pair of immediately adjacent contact elements. The said distances between the soldering sections are measured in the row direction of the contact elements in this case. By means of the invention, a locally increased distance between the soldering sections can be created without increasing the dimensions of the connector strip. Since the local increase need take place only in the soldering region, the plug-in contact side of the connector strip can be left unchanged and, in particular, the previous contact spacing can be retained.

Such a solution permits a local increase in the clearances and creepage distances in the soldering region of the electrical contact elements without affecting the overall size of the system. In particular, the plug-in contacts can continue to be spaced uniformly apart from one another in the predetermined contact spacing. A modified, variable contact spacing or modified distances as compared with the contact spacing on the plug-in contact side can be realized on the side of the soldering sections alone.

In this way, installation space is saved, in particular as compared with solutions in which the increased or requisite clearances and creepage distances are implemented by leaving out individual contact elements, which is to say by inserting dummy poles, since just such a dummy pole is not necessary with the solution according to the invention. In particular, it is also not necessary to increase the contact spacing on the plug-in contact side in order to achieve the necessary clearances and creepage distances.

Consequently, it is possible to implement a variable clearance on the solder side with a uniform contact spacing on the plug-in contact side. The soldering sections that are spaced farther apart from one another, or the contact elements thereof, can be used for, e.g., carrying special potentials such as ground potential. The connector strip can have at least four or more contact elements, for example.

The contact elements can each be designed as a one-piece or multi-piece sheet-metal component, for example as a stamped and bent component. In particular, the plug-in contact of a contact element can be formed in one piece with the solder terminal of the same contact element. The plug-in contacts can be designed as male or female plug-in contacts, e.g., pin contacts, blade contacts, bifurcated contacts. The connector strip can also be populated with different contact elements in which different types of plug-in contacts are used. The electrical plug-in contact in question is configured for insertion of a mating plug contact associated as a mating part so that an electrical plug-and-socket connection is formed by this means.

The contact elements may each have a connecting section by which means the plug-in contact of the contact element is connected to the soldering section of the contact element, wherein the contact elements of the first pair are shaped differently from one another in the region of their soldering sections and/or of their connecting sections. Accordingly, the contact elements can be shaped variably on the other side of the plug-in contact. The plug-in contacts themselves can be left unchanged.

The soldering sections can be designed as soldering sections configured for surface mounting (SMD mounting). The attachment of the soldering sections is then accomplished by soldering to the surface of the electrical printed circuit board.

The soldering sections can be designed as solder pins that are configured for insertion into a through opening of the electrical printed circuit board. This permits an especially robust attachment of the connector strip to the electrical printed circuit board by the solder pins.

The connector strip can define a plug-in plane for each plug-in contact, wherein the plug-in planes of the adjacently arranged plug-in contacts can be spaced uniformly apart from one another in the contact spacing, wherein, for the first pair of contact elements, the soldering section of at least one contact element can be arranged outside the plug-in plane of this contact element. The plug-in plane can extend through the center of the respective plug-in contact in a direction orthogonal to the row direction of the plug-in contacts, for example. Owing to such soldering sections offset with respect to the plug-in plane, the desired increased distance of the soldering sections can be implemented in a simple manner, in particular by simple and economical production of the contact elements. It is not necessary to design the contact elements completely afresh for this purpose, but instead it suffices to vary the shaping of the contact elements in the row direction.

The connector strip can, for example, be populated with contact elements where one, multiple, or all but one contact element are designed such that the respective soldering section is located in the center in the plug-in plane of the contact element.

The soldering section for each contact element can be arranged outside the plug-in plane of said contact element. In this way, the distance between the soldering sections of the first pair of contact elements can be maximized without the number of shaping variants of contact elements being excessively high. For example, it is possible to implement just two different shapings of contact elements, e.g., contact elements that are designed with mirror symmetry to one another.

The soldering sections of the contact elements of the first pair of contact elements can be arranged with mirror symmetry to one another. In this way, the distance between the soldering sections of the first pair of contact elements can be maximized in a simple manner.

The contact elements can be designed as angled contact elements, wherein the plug-in direction of the plug-in contacts is oriented parallel to the plane of the electrical printed circuit board. Accordingly, when viewed in the row direction, the contact elements are angled such that the plug-in direction of the plug-in contacts points in one direction, and the direction in which the soldering sections project from the respective connecting section points in a different direction orthogonal thereto.

The contact elements can be arranged in the insulating housing with no spatial interruption in the contact spacing, in particular with no dummy pole between adjacent contact elements. In this way, the required installation space for the connector strip can be minimized.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a connector strip in a perspective view,

FIG. 2 shows the connector strip from FIG. 1 with a mating connector plugged onto it,

FIG. 3 shows the connector strip from FIG. 1 in a view of the mating face side,

FIG. 4 shows the connector strip from FIG. 1 in a rear view of the housing side that faces away from the mating face side, and

FIGS. 5 and 6 show two contact elements in different perspective views.

### DETAILED DESCRIPTION

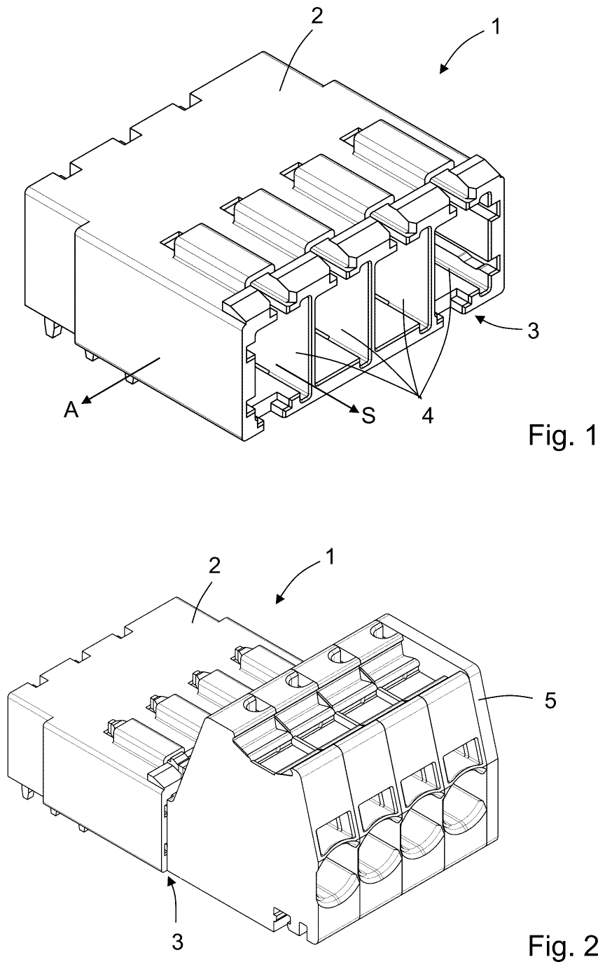

FIG. 1 shows a connector strip 1 that has an insulating housing 2. Formed in the insulating housing 2 are multiple cavities 4, in each of which is arranged an electrical contact element 10 or at least the plug-in contact 6 of such a contact element 10.

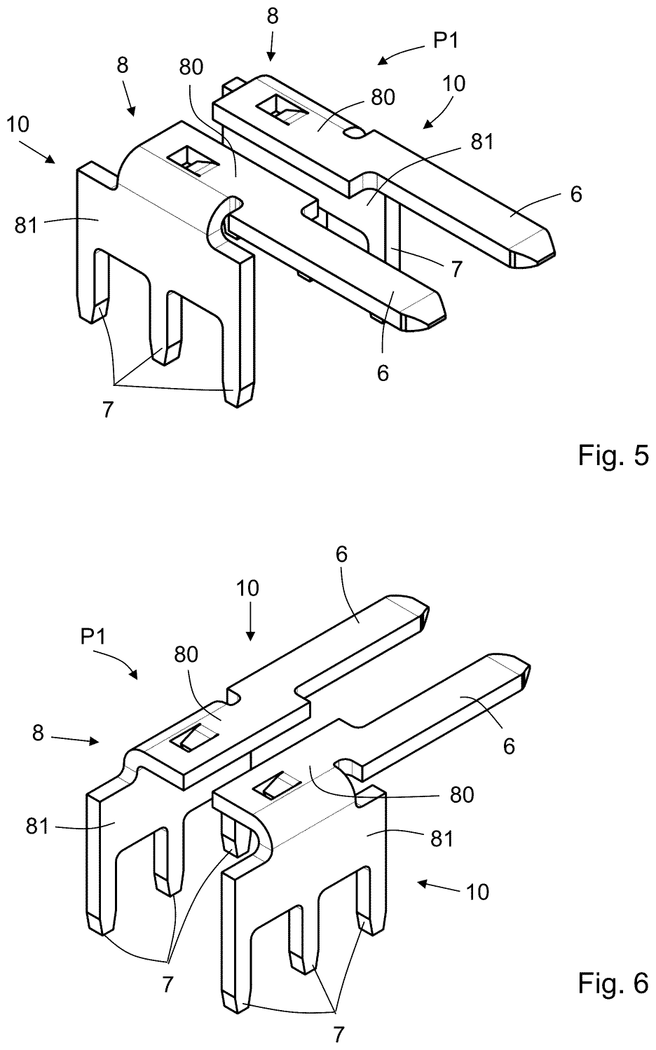

FIGS. 5 and 6 show two contact elements 10 in different views. The contact elements 10 are formed with mirror symmetry to one another. Each of the contact elements 10 has an electrical plug-in contact 6 that is configured to mate with a mating plug contact of a mating connector. Each contact element 10 has at least one soldering section 7, wherein, in the exemplary embodiment depicted, each contact element 10 can have three soldering sections 7 in the form of solder pins. The soldering sections 7 are connected to the plug-in contact 6 by a connecting section 8 and are formed in one piece therewith. Alternatively to the solder pins, it is also possible to use plug-in contacts that are inserted into plug-in contact openings of a printed circuit board in an interlocking and/or frictional manner.

The contact elements 10 are arranged next to one another in the insulating housing 2 in a row direction A depicted in FIG. 1. The connector strip 1 serves to mate with a mating connector 5, as is evident in FIG. 2. The connector strip 1 can be mated with the mating connector 5 in a plug-in direction S. In this process, the electrical contact elements 10 present in the insulating housing 2, or the plug-in contacts thereof, are electrically contacted by mating contacts of the mating connector 5 so that an electrical plug-and-socket connection is established. The mating connector 5 in this case is to be mated with the connector strip 1 from a mating face side 3 thereof.

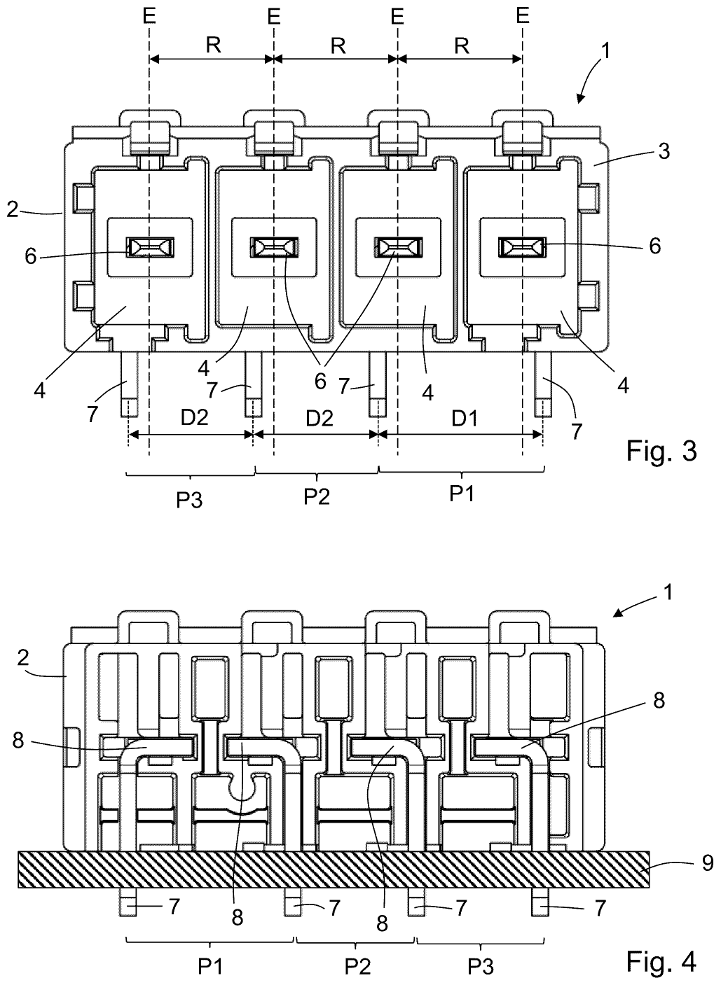

FIG. 3 shows the connector strip 1 in a view of the mating face side 3. It is evident that one electrical plug-in contact 6 is arranged in each receiving cavity 4. The soldering sections 7 of the various contact elements 10 project out of the insulating housing 2 on a different housing side from the mating face side 3. For example, each contact element 10 can have exactly one electrical plug-in contact 6 and one associated soldering section 7. The plug-in contacts 6 are arranged in a predetermined contact spacing R in this case, which is to say spaced uniformly apart from one another by the contact spacing R in each case.

Also depicted in FIG. 3 are plug-in planes E, which is to say one plug-in plane E for each plug-in contact 6, wherein the longitudinal extent of the plug-in contact 6 extends within the plug-in plane E. The plug-in planes E each extend orthogonally to the row direction A. It can be seen that, for each contact element 10, the soldering section 7 thereof is arranged offset from the plug-in plane E in the row direction A, for example in such a manner that the soldering section 7 is arranged outside the plug-in plane E of this contact element 10 for each contact element 10.

It can also be seen that the soldering sections 7 have different distances from one another. In a first pair P1 of adjacent contact elements 10, their likewise adjacent soldering sections 7 are arranged at a distance D1 from one another. In a second pair P2 of adjacent contact elements, their soldering sections are arranged at a distance D2 from one another. In a third pair P3 of contact elements, their soldering sections 7 are arranged at a distance D2 from one another. As is evident, the distance D1 is greater than the distance D2 in this case.

FIG. 4 shows a rear view of the connector strip from FIGS. 1 and 3, in which the soldering sections 7 are evident together with connecting sections 8 of each contact element 10. It is shown in addition that the connector strip 1 is attached to an electrical printed circuit board 9. It is evident that the different distances D1, D2 are implemented by the different formation of the individual contact elements 10, in particular by different layout of the connecting sections 8. In particular, the contact elements 10 of the first pair P1 are formed and arranged with mirror symmetry to one another, at least in the region of their connecting sections 8. The soldering sections 7 in this case are arranged with an offset from the plug-in plane E of the plug-in contacts 6, which is to say outside the plug-in plane E.

As FIGS. 5 and 6 show, the connecting section 8 has a horizontal section 80, which extends parallel to the plug-in direction S and to the row direction A when in the installed state in the insulating housing 2 of the connector strip 1. The horizontal section 80 transitions through a curved section into a vertical section 81 of the connecting section 8. The vertical section 81 is essentially parallel to the plug-in plane E.

Consequently, the contact elements 10 are available in at least two embodiments, in particular in such a manner that they are designed with mirror symmetry with regard to the layout of their connecting sections 8. In this way, the desired distance D1 or D2 between respective pairs of contact elements can be set by suitable population of the insulating housing 2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A connector strip configured for soldering to an electrical printed circuit board, the connector strip comprising:
an insulating housing; and
at least two electrical contact elements that are fixed in place in the insulating housing and are arranged next to, and spaced apart from, one another in a row direction,
wherein each contact element comprises at least one electrical plug-in contact that, on a mating face side of the connector strip, is configured for insertion of a mating plug contact associated as a mating part, and at least one soldering section that is configured for soldering into or soldering onto a solder terminal of the electrical printed circuit board,
wherein the electrical plug-in contacts are spaced uniformly apart from one another in a predetermined contact spacing in the row direction,
wherein a distance between the soldering sections in a first pair of immediately adjacent contact elements is greater than a distance defined by the contact spacing and/or is greater than a distance between the soldering sections of a second pair of immediately adjacent contact elements.

2. The connector strip according to claim 1, wherein the contact elements each have a connecting section via which the plug-in contact of the contact element is connected to the soldering section of the contact element, and wherein the contact elements of the first pair are shaped differently from one another in a region of their soldering sections and/or of their connecting sections.

3. The connector strip according to claim 1, wherein the soldering sections are solder pins that are configured for insertion into a through opening of the electrical printed circuit board.

4. The connector strip according to claim 1, wherein the connector strip defines a plug-in plane for each plug-in contact, wherein the plug-in planes of the adjacently arranged plug-in contacts are spaced uniformly apart from one another in the contact spacing, and wherein, for the first pair of contact elements, the soldering section of at least one contact element is arranged outside the plug-in plane of this contact element.

5. The connector strip according to claim 4, wherein the soldering section for each contact element is arranged outside the plug-in plane of the contact element.

6. The connector strip according to claim 1, wherein the soldering sections of the contact elements of the first pair of contact elements are arranged with mirror symmetry to one another.

7. The connector strip according to claim 1, wherein the contact elements are designed as angled contact elements, and wherein the plug-in direction of the plug-in contacts is oriented substantially parallel to a plane of the electrical printed circuit board.

8. The connector strip according to claim 1, wherein the contact elements are arranged in the insulating housing with no spatial interruption in the contact spacing or with no dummy pole between adjacent contact elements.
